(19) United States
(12) Patent Application Publication
(10) Pub. No.: US 2020/0286207 A1
(43) Pub. Date: Sep. 10, 2020

(54) IMAGE PROCESSING DEVICE, IMAGE PROCESSING METHOD, AND COMPUTER READABLE RECORDING MEDIUM

(71) Applicant: Sony Olympus Medical Solutions Inc., Tokyo (JP)

(72) Inventor: Taihei MICHIHATA, Kanagawa (JP)

(73) Assignee: Sony Olympus Medical Solutions Inc., Tokyo (JP)

(21) Appl. No.: 16/729,521

(22) Filed: Dec. 30, 2019

(30) Foreign Application Priority Data
Mar. 6, 2019 (JP) 2019-040462

(51) Int. Cl. G06T 3/40; G06F 3/147

(52) U.S. Cl. CPC G06T 3/4092; G06T 2200/16; G06T 3/4007; G06F 3/147

(57) ABSTRACT

An image processing device includes: a memory; and a processor including hardware. The processor is configured to: execute, on first observed image information input externally and having predetermined number of pixels generated by capturing a subject, expansion processing to expand number of pixels up to a resolution of a display configured to display a display image having highest resolution among a plurality of displays being connectable to the image processing device, and generate and output second observed image information having number of pixels larger than the predetermined number of pixels; and execute reduction processing to reduce the number of pixels on the second observed image information, and generate and output third observed image information having number of pixels smaller than the predetermined number of pixels.

This application claims priority from Japanese Application No. 2019-040462, filed on Mar. 6, 2019, the contents of which are incorporated by reference herein in its entirety.

### BACKGROUND

The present disclosure relates to an image processing device, an image processing method, and a

In the related art, a technique for generating images according to multiple types of television signal standards in an endoscope has been known (e.g., see JP 2015-12958 A). With this technique, an endoscopic image captured by an endoscope is converted into a video signal in accordance with the television signal standards, the resolution, and the aspect ratio of an output display device, and the converted video signal is subjected to expansion processing, including a black image area, which is generated in addition to the endoscopic image, and output to the display device.

### SUMMARY

JP 2015-12958 A described above has not considered simultaneously outputting images having different resolutions to display devices having different resolutions. When the images are output to the display devices having different resolutions, there is a problem that any one of the display devices displays a low-resolution image.

There is a need for an image processing device, an image processing method, and a computer readable recording medium that may prevent lowering of resolution of an image even when the image is output to a plurality of display devices having different resolutions.

According to one aspect of the present disclosure, there is provided an image processing device including: a memory; and a processor comprising hardware, wherein the processor is configured to: execute, on first observed image information input externally and having predetermined number of pixels generated by capturing a subject, expansion processing to expand number of pixels up to a resolution of a display configured to display a display image having highest resolution among a plurality of displays being connectable to the image processing device, and generate and output second observed image information having number of pixels larger than the predetermined number of pixels; and execute reduction processing to reduce the number of pixels on the second observed image information, and generate and output third observed image information having number of pixels smaller than the predetermined number of pixels.

### BRIEF DESCRIPTION OF THE DRAWINGS

FIG. 1 schematically illustrates a configuration of an endoscope system according to a first embodiment;

FIG. 2 is a block diagram illustrating a functional configuration of a camera head and a control device provided in the endoscope system according to the first embodiment;

FIG. 3 is a flowchart illustrating an outline of processing executed by a control device 9 according to the first embodiment;

FIG. 4 schematically illustrates a configuration of an endoscope system according to a second embodiment; and

FIG. 5 schematically illustrates a configuration of a surgical microscope system according to a third embodiment.

### DETAILED DESCRIPTION

Hereinafter, modes for carrying out the present disclosure (hereinafter referred to as “embodiments”) will be described in detail with reference to the accompanying drawings. Note that the present disclosure is not limited to the following embodiments. In addition, the drawings referred to in the following description merely illustrate the shape, size, and positional relationship schematically to an extent sufficient to understand the present disclosure. That is, the present disclosure is not exclusively limited to the shape, size, and positional relationship illustrated in the drawings. Further, in the drawings, the same portions are denoted by the same reference numerals. Further, an endoscope system is described as an example of a medical observation system according to the present disclosure. In addition, in the drawings, the same portions are denoted by the same reference numerals.

### First Embodiment

Configuration of Endoscope System

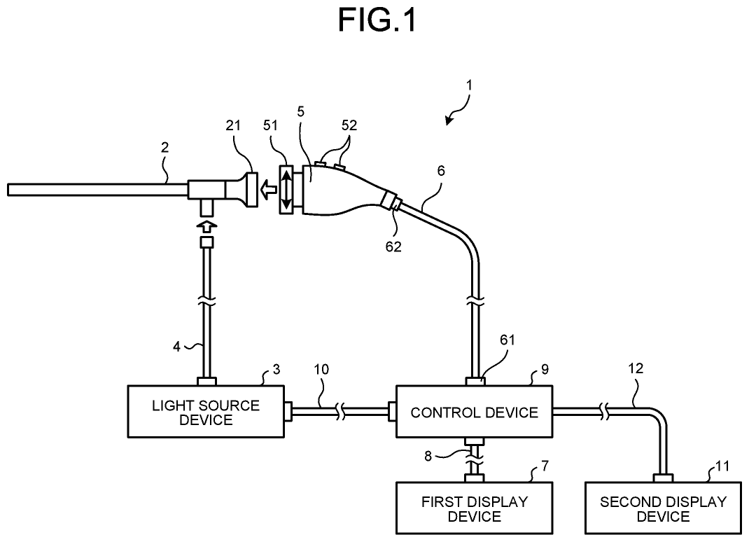

FIG. 1 schematically illustrates a configuration of an endoscope system according to a first embodiment. An endoscope system 1 illustrated in FIG. 1 is used in the medical field to observe a subject such as a living body of a human or an animal by being inserted into the inside (in vivo) of the body of the subject to capture an image of the inside and display the obtained image. Note that, in the first embodiment, a rigid endoscope system using a rigid endoscope (inserting portion 2) illustrated in FIG. 1 is described as the endoscope system 1, but the present disclosure is not limited to this, and a flexible endoscope system, for example, may be used as the endoscope system.

The endoscope system 1 illustrated in FIG. 1 includes the inserting portion 2 (endoscope), a light source device 3, a light guide 4, a camera head 5 (endoscope imaging device), a first transmission cable 6, a first display device 7, a second transmission cable 8, a control device 9, a third transmission cable 10, a second display device 11, and a fourth transmission cable 12.

The inserting portion 2 is a rigid or at least partially flexible, has an elongated shape, and is inserted into a subject such as a patient. Provided inside the inserting portion 2 is an optical system configured with one or a plurality of lenses to couple observed images.

The light source device 3 is connected to one end of the light guide 4. The light source device 3 emits (supplies) light for illuminating the inside of the subject to one end of the light guide 4 under the control of the control device 9. The light source device 3 is formed using a semiconductor laser element such as a light emitting diode (LED) light source that emits white light or a laser diode (LD). The light source device 3 and the control device 9 may be provided separately to communicate each other, as illustrated in FIG. 1, or may be integrated.

One end of the light guide 4 is detachably connected to the light source device 3, while the other end is detachably connected to the inserting portion 2. The light guide 4 guides the light emitted from the light source device 3 from one end to the other end and supplies the light to the inserting portion 2.

The camera head 5 is detachably connected to an eyepiece 21 of the inserting portion 2. Under the control of the control device 9, the camera head 5 generates an imaging signal by capturing an observed image formed by the inserting portion 2, and converts the imaging signal (electric signal) into an optical signal to output the optical signal. In addition, the camera head 5 includes an operation ring unit 51 provided rotatably in the circumferential direction, and a plurality of input units 52 that receive input of instruction signals for instructing various operations of the endoscope system 1.

One end of the first transmission cable 6 is detachably connected to the control device 9 via a first connector portion 61, while the other end is connected to the camera head 5 via a second connector portion 62. The first transmission cable 6 transmits the imaging signal output from the camera head 5 to the control device 9, and transmits a control signal, a synchronization signal, a clock signal, power, and the like, which are output from the control device 9, to the camera head 5.

The first display device 7 is connectable to the control device 9 via the second transmission cable 8 and displays, under the control of the control device 9, a display image (which is hereinafter referred to as a “first display image”) in accordance with the image signal processed in the control device 9 and various information related to the endoscope system 1. In addition, the first display device 7 has a monitor size of 31 inches or more and preferably 55 inches or more. Note that, although the first display device 7 in the first embodiment has a monitor size of 31 inches or more, the monitor size is not limited to this, and may be any size capable of displaying the image having the resolution equal to the number of pixels of a 4K image, which is, for example, 8 megapixels (e.g., 3,840×2,160 pixels, so-called 4K resolution) or more, and more preferably 32 megapixels (e.g., 7,680×4,320 pixels, so-called 8K resolution) or more.

One end of the second transmission cable 8 is detachably connected to the first display device 7, while the other end is detachably connected to the control device 9. The second transmission cable 8 transmits a display image in accordance with the image signal processed in the control device 9 to the first display device 7 or the second display device 11.

The control device 9 is formed using a memory and a processor including hardware such as a central processing unit (CPU), a graphics processing unit (GPU), an application specific integrated circuit (ASIC), and a field programmable gate array (FPGA). According to a program recorded in the memory, operations of the light source device 3, the camera head 5, the first display device 7, and the second display device 11 are controlled comprehensively via the first to third transmission cables 6, 8, and 10.

One end of the third transmission cable 10 is detachably connected to the light source device 3, while the other end is detachably connected to the control device 9. The third transmission cable 10 transmits a control signal from the control device 9 to the light source device 3.

The second display device 11 is connectable to the control device 9 via the fourth transmission cable 12, and displays, under the control of the control device 9, a display image (which is hereinafter referred to as a “second display image”) in accordance with the image signal processed in the control device 9 and various information related to the endoscope system 1. The second display device 11 is formed using liquid crystal, organic EL, or the like. In addition, the second display device 11 has a monitor size of 31 inches or more and preferably 55 inches or more. Note that, although the second display device 11 in the first embodiment has a monitor size of 31 inches or more, the monitor size is not limited to this, and may be any size capable of displaying the image having the resolution equal to the number of pixels of a Full HD image which is, for example, 2 megapixels (e.g., 1,920×1,080 pixels, so-called 2K resolution) or more. In addition, the resolution of the second display device 11 only needs to be smaller than the resolution of the first display device 7. That is, the resolution of the second display device 11 is 2K when the resolution of the first display device 7 is 4K, and the resolution of the second display device 11 is 4K when the resolution of the first display device 7 is 8K.

One end of the fourth transmission cable 12 is detachably connected to the second display device 11, while the other end is detachably connected to the control device 9. The fourth transmission cable 12 transmits a display image in accordance with the image signal processed in the control device 9 to the second display device 11.

Detailed Configuration of Camera Head and Control Device

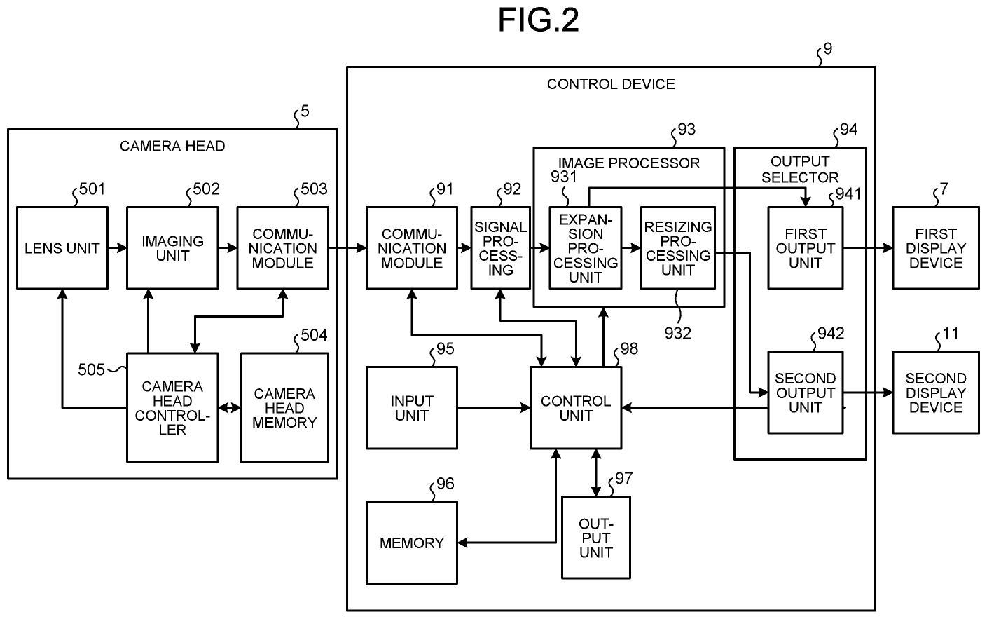

Next, the functional configuration of the camera head 5 and the control device 9 is described. FIG. 2 is a block diagram illustrating functional configurations of the camera head 5 and the control device 9 included in the endoscope system 1. Note that, in FIG. 2, the inserting portion 2, the light source device 3, the light guide 4, the first transmission cable 6, the second transmission cable 8, and the third transmission cable 10 are omitted for convenience of explanation.

Configuration of Camera Head

First, the configuration of the camera head 5 is described.

The camera head 5 includes a lens unit 501, an imaging unit 502, a communication module 503, a camera head memory 504, and a camera head controller 505.

The lens unit 501 is formed using one or a plurality of lenses to generate an image of a subject on the light receiving surface of the imaging unit 502. In addition, the lens unit 501 performs auto focus (AF) for changing the focal position and optical zooming for changing the focal length by moving the lens along the optical axis direction by a driving unit, which is not illustrated, under the control of the camera head controller 505. Note that, in the first embodiment, the lens unit 501 may include a diaphragm mechanism and an optical filter mechanism that may be inserted and removed on the optical axis.

The imaging unit 502 (imaging element) receives the subject image formed by the inserting portion 2 and the lens unit 501 and performs photoelectric conversion to generate an imaging signal (RAW data) to output the imaging signal to the communication module 503 under the control of the camera head controller 505. The imaging unit 502 is formed using a charge coupled device (CCD), a complementary metal oxide Semiconductor (CMOS), or the like. The imaging unit 502 has a resolution of, for example, 2 megapixels (e.g., 1,920×1,080 pixels, so-called 2K resolution) or more and less than 8 megapixels (e.g., 3,840×2,160 pixels, so-called 4K resolution).

The communication module 503 outputs various signals transmitted from the control device 9 via the first transmission cable 6 to individual parts of the camera head 5. In addition, the communication module 503 performs parallel-to-serial conversion processing or the like on the imaging signal generated by the imaging unit 502, information of the current state of the camera head 5, or the like, via the first transmission cable 6 to output the imaging signal, information, or the like to the control device 9.

The camera head memory 504 stores camera head information that identifies the camera head 5 and various programs executed by the camera head 5. Here, the camera head information includes the number of pixels of the imaging unit 502, an identification ID of the camera head 5, and the like. The camera head memory 504 is formed using a volatile memory, a nonvolatile memory, or the like.

The camera head controller 505 controls the operations of individual parts of the camera head 5 in accordance with various signals input from the communication module 503. The camera head controller 505 is formed using a memory and a processor including hardware including a CPU and the like.

Configuration of Control Device

Next, the configuration of the control device 9 is described.

The control device 9 includes a communication module 91, a signal processing unit 92, an image processor 93, an output selector 94, an input unit 95, a memory 96, an output unit 97, and a control unit 98.

The communication module 91 outputs various signals including the imaging signal input from the camera head 5 to the control unit 98 and the signal processing unit 92. Further, the communication module 91 transmits various signals input from the control unit 98 to the camera head 5. Specifically, the communication module 91 performs parallel-to-serial conversion processing on the signal input from the control unit 98 and outputs the converted signal to the camera head 5. Further, the communication module 91 performs serial-to-parallel conversion processing on the signal input from the camera head 5 and outputs the converted signal to individual parts of the control device 9.

The signal processing unit 92 performs signal processing such as noise reduction and A/D conversion on the imaging signal input from the camera head 5 via the communication module 91 and outputs the processed signal to the image processor 93.

The image processor 93 performs various types of image processing on the imaging signal input from the signal processing unit 92, and outputs the processed signal to the output selector 94 under the control of the control unit 98. Here, the predetermined image processing includes various types of known image processing such as interpolation, color correction, color enhancement, and contour enhancement. The image processor 93 is formed using a memory and a processor including hardware such as the GPU, FPGA, and CPU. In the first embodiment, the image processor 93 functions as an image processing device. The image processor 93 includes at least an expansion processing unit 931 and a resizing processing unit 932.

The expansion processing unit 931 performs, under the control of the control unit 98, expansion processing to expand the number of pixels up to the resolution of the first display device 7 that displays a display image having the highest resolution of the first and second display devices 7 and 11, on the first observed image information input from the signal processing unit 92. Specifically, the expansion processing unit 931 performs, as the expansion processing, the interpolation processing to interpolate the pixels up to the resolution of the first display device 7, which displays the display image having the highest resolution, on first observed image information having the number of pixels larger than the number of pixels of the Full HD image, and generates second observed image information with the number of pixels equal to or larger than 4K resolution to output the second observed image information to the output selector 94 and the resizing processing unit 932.

The resizing processing unit 932 performs reduction processing for reducing the number of pixels on the second observed image information input from the expansion processing unit 931 under the control of the control unit 98, and generates and outputs third observed image information with a smaller number of pixels than the pixels at the imaging unit 502. Specifically, the resizing processing unit 932 performs, as the reduction processing, decimation processing to decimate the number of pixels on the second observed image information to generate the third observed image information having the number of pixels of 2K to output the third observed image information to the output selector 94.

The output selector 94 is at least connected to the first display device 7 or the second display device 11. The output selector 94 includes a first output unit 941 connected to the first display device 7 to output the second observed image information to the first display device 7 and a second output unit 942 connected to the second display device 11 to output the third observed image information to the second display device 11.

The input unit 95 is formed using a keyboard, a mouse, a touch panel, or the like. The input unit 95 accepts input of various types of information by user operations.

The memory 96 is formed using a volatile memory, a nonvolatile memory, a frame memory, or the like. The memory 96 stores various programs to be executed by the endoscope system 1 and various data to be used during processing. Note that the memory 96 may further include a memory card or the like that may be attached to the control device 9.

The output unit 97 is formed using a speaker, a printer, a display, or the like. The output unit 97 outputs various information related to the endoscope system 1.

The control unit 98 comprehensively controls individual parts of the endoscope system 1. The control unit 98 is formed using the memory and the hardware such as the CPU.

Processing in Control Device

Next, processing executed by the control device 9 is described.

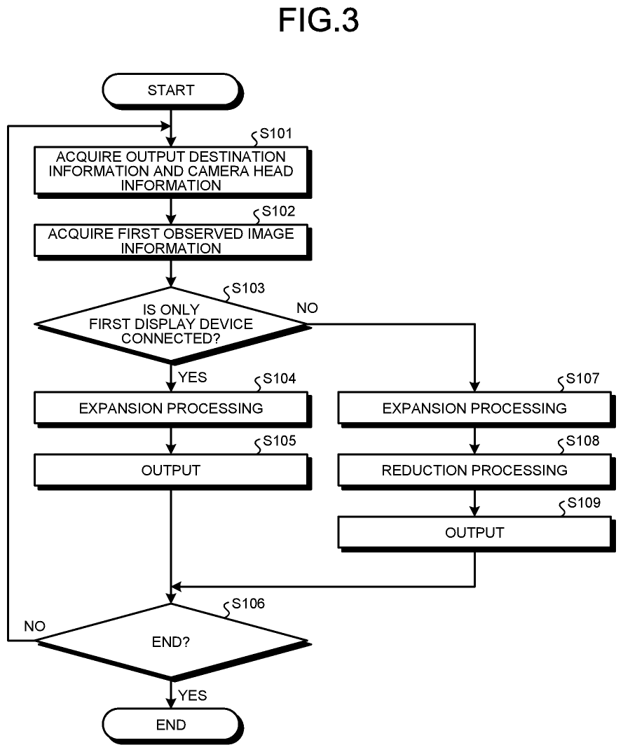

FIG. 3 is a flowchart illustrating an outline of processing executed by the control device 9.

As illustrated in FIG. 3, first, the control unit 98 acquires output destination information indicating the resolution of the display device output from the output selector 94 and camera head information indicating the resolution of the camera head 5 via the communication module 91 (step S101).

Subsequently, the control unit 98 acquires the first observed image information which is an imaging signal generated by the camera head 5 via the communication module 91 (step S102).

Thereafter, the control unit 98 determines whether only the first display device 7 is connected to the output selector 94 in accordance with the output destination information (step S103). When the control unit 98 determines that only the first display device 7 is connected to the output selector 94 (step S103: Yes), the control device 9 proceeds to step S104 which will be described later. On the other hand, when the control unit 98 determines that only the first display device 7 is not connected to the output selector 94 (step S103: No), the control device 9 proceeds to step S107 which will be described later.

In step S104, the expansion processing unit 931 executes expansion processing on the first observed image information input from the signal processing unit 92 under the control of the control unit 98. Specifically, the expansion processing unit 931 performs, as the expansion processing, on the first observed image information having the number of pixels larger than the number of pixels of the Full HD image to interpolate pixels up to the resolution of the first display device 7 that displays the display image having the highest resolution to generate second observed image information having the number of pixels equal to or larger than the number of pixels of 4K, and outputs the generated second observed image information to the first output unit 941 of the output selector 94.

Subsequently, the first output unit 941 outputs third observed image information to the first display device 7 under the control of the control unit 98 (step S105). Thus, the first display device 7 may display the first display image of 4K image quality corresponding to the second observed image information.

Subsequently, when an instruction signal for ending the observation of the subject is input from the input unit 95 (step S106: Yes), the control device 9 ends the present processing. On the other hand, when no instruction signal for ending the observation of the subject is input from the input unit 95 (step S106: No), the control device 9 returns to step S101 described above.

In step S107, the expansion processing unit 931 executes, under the control of the control unit 98, the expansion processing on the first observed image information input from the signal processing unit 92. In this case, the expansion processing unit 931 outputs the second observed image information to the first output unit 941 and the resizing processing unit 932.

Subsequently, the resizing processing unit 932 performs, under the control of the control unit 98, the reduction processing on the second observed image information input from the expansion processing unit 931 (step S108). Specifically, the resizing processing unit 932 executes decimation processing to decimate the number of pixels as the reduction processing on the second observed image information to generate the third observed image information having the number of pixels of 2K, and outputs the generated third observed image information to the second output unit 942.

Subsequently, the first output unit 941 outputs the second observed image information to the first display device 7, and the second output unit 942 outputs the third observed image information to the second display device 11 (step S109). Accordingly, the first display device 7 may display the first 4K display image, and the second display device 11 may display the second 2K display image. As a result, even when images are simultaneously output to the first display device 7 and the second display device 11 having different resolutions, it is possible to prevent the lowering of the resolution. After step S109, the control device 9 proceeds to step S106.

According to the first embodiment described above, the image processor 93 performs the expansion processing on the first observed image information input from the camera head 5 via the communication module and the signal processing unit 92 to generate the second observed image information having the number of pixels different from the number of pixels of the first observed image information, and performs the reduction processing on the second observed image information to generate third observed image information, thus preventing the lowering of the resolution even when the images having different resolutions are output to the first display device 7 or the second display device 11.

Further, according to the first embodiment, the image processor 93 performs the interpolation processing, as the expansion processing, to interpolate pixels up to the resolution of the first display device 7 that displays the display image having the highest resolution, while performing the decimation processing, as the reduction processing, to decimate the pixels, thus preventing the lowering of the resolution even when the images having different resolutions are output to the first display device 7 or the second display device 11.

Further, according to the first embodiment, the second observed image information is output to the first output unit 941, and the third observed image information is output to the second output unit 942, so that it is possible to prevent the lowering of the resolution even when the image is output to the first display device 7 or the second display device 11 having different resolutions.

Further, according to the first embodiment, the image processor 93 performs the expansion processing on the first observed image information to generate the second observed image information having the same number of pixels as the 4K pixels, while performing the reduction processing on the second observed image information to generate the third observed image information having the same number of pixels as the 2K pixels, so that it is possible to prevent the lowering of the resolution even when the image is output to the first display device 7 or the second display device 11 having different resolutions.

Note that the output selector 94 includes the first output unit 941 and the second output unit 942 in the first embodiment, but the output selector 94 is not limited to this. Alternatively, the output selector 94 may include only one output circuit, and the first display device 7 may include the resizing processing unit 932 described above, so that the second observed image information may be output to the first display device 7 where the reduction processing is performed by the resizing processing unit 932 provided on the first display device 7 and the processed observed image information is output to the second display device 11.

### Second Embodiment

Next, a second embodiment is described. The first embodiment described above has been applied to the rigid endoscope system with a rigid mirror, but the second embodiment is applied to a flexible endoscope system with a flexible endoscope. Note that the same constituent components as those in the endoscope system 1 according to the first embodiment described above are denoted by the same reference numerals, and detailed description thereof is omitted.

Schematic Configuration of Endoscope System

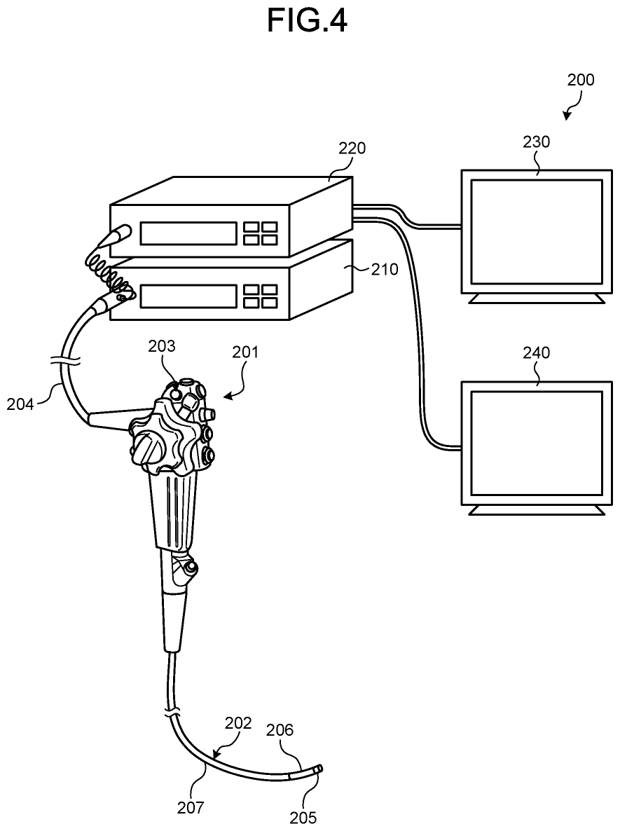

FIG. 4 schematically illustrates a configuration of the endoscope system according to the second embodiment. An endoscope system 200 illustrated in FIG. 4 includes an endoscope 201 that captures an in-vivo image of an observed region by inserting an inserting portion 202 into a subject and generates an imaging signal, a light source device 210 that supplies illumination light to the endoscope 201, a control device 220 that performs predetermined image processing on the imaging signal acquired by the endoscope 201 and comprehensively controls the entire operation of the endoscope system 200, a first display device 230 that displays the in-vivo image subjected to the image processing by the control device 220, and a second display device 240 that displays the in-vivo image subjected to the image processing by the control device 220.

The endoscope 201 includes at least the lens unit 501 and the imaging unit 502 described above.

The control device 220 at least includes the communication module 91, the signal processing unit 92, the image processor 93, the output selector 94, the input unit 95, the memory 96, the output unit 97, and the control unit 98 described above.

The first display device 230 has a monitor size of 31 inches or more and preferably 55 inches or more. The first display device 230 has a monitor size of 31 inches or more, but the monitor size is not limited to this. Alternatively, another monitor size, for example, a monitor size capable of displaying image having the resolution of, for example, 8 megapixels (e.g., 3,840×2,160 pixels, so-called 4K resolution) or more, and more preferably 32 megapixels (e.g., 7,680×4,320 pixels, so-called 8K resolution) or more may be employed.

The second display device 240 has a monitor size of 31 inches or more and preferably 55 inches or more. The second display device 240 has a monitor size of 31 inches or more, but is not limited to this. Alternatively, another monitor size, for example, a monitor size capable of displaying image having the resolution of, for example, 2 megapixels (e.g., 1,920×1,080 pixels, so-called 2K resolution) or more may be employed.

According to the second embodiment described above, the same effect as the effect of the first embodiment described above may be obtained even with the flexible endoscope system 200.

### Third Embodiment

Next, a third embodiment is described. The first and second embodiments described above are the endoscope system, but the third embodiment is applied to a surgical microscope system. Note that the same constituent components as those in the endoscope system 1 according to the first embodiment described above are denoted by the same reference numerals, and detailed description thereof is omitted.

Configuration of Surgical Microscope System

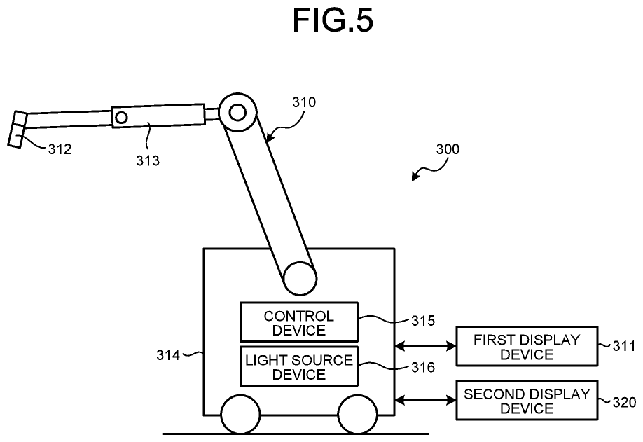

FIG. 5 schematically illustrates a configuration of the surgical microscope system according to the third embodiment. A surgical microscope system 300 illustrated in FIG. 5 includes a microscope device 310 which is a medical imaging device that acquires an image for observing the subject by image capturing, a first display device 311 that displays an image captured by the microscope device 310, and a second display device 320. Note that the first display device 311 or the second display device 320 may be integrated in the microscope device 310.

The microscope device 310 includes a microscope portion 312 for expanding and capturing a minute part of the subject, a support portion 313 connected to a proximal end of the microscope portion 312 and including an arm rotatably supporting the microscope portion 312, and a base unit 314 rotatably holding the proximal end of the support portion 313 and movable on a floor surface. The base unit 314 includes a control device 315 that controls the operation of the surgical microscope system 300, and a light source device 316 that generates illumination light that irradiates the subject from the microscope device 310. Note that the control device 315 at least includes the communication module 91, the signal processing unit 92, the image processor 93, the output selector 94, the input unit 95, the memory 96, the output unit 97, and the control unit 98 described above. In addition, the base unit 314 may be fixed on the ceiling, a wall surface, or the like, instead of being provided movably on the floor, to support the support portion 313.

The microscope portion 312 has, for example, a cylindrical shape and includes the lens unit 501 and the imaging unit 502 described above inside the microscope portion 312. On the side surface of the microscope portion 312, a switch that receives operation instruction for the microscope device 310 is provided. A cover glass (not illustrated) for protecting the inside is provided on the open surface at the lower end of the microscope portion 312.

The first display device 311 has a monitor size of 31 inches or more and preferably 55 inches or more. The first display device 311 has a monitor size of 31 inches or more, but the monitor size is not limited to this.

Alternatively, another monitor size, for example, a monitor size capable of displaying images having the resolution of, for example, 8 megapixels (e.g., 3,840×2,160 pixels, so-called 4K resolution) or more, and more preferably 32 megapixels (e.g., 7,680×4,320 pixels, so-called 8K resolution) or more may be employed.

The second display device 320 has a monitor size of 31 inches or more and preferably 55 inches or more. The second display device 320 has a monitor size of 31 inches or more, but the monitor size is not limited to this. Alternatively, another monitor size, for example, a monitor size capable of displaying images having the resolution of, for example, 2 megapixels (e.g., 1,920×1,080 pixels, so-called 2K resolution) or more may be employed.

The surgical microscope system 300 configured as described above operates in a manner that a user such as an operator operates various switches, while holding the microscope portion 312, to move the microscope portion 312, perform zooming operation, switch the illumination light, and the like. Note that the shape of the microscope portion 312 is preferably in an elongated shape extending long and thin in an observing direction to allow the user to easily grasp and change the viewing direction. For this reason, the shape of the microscope portion 312 may be other than a cylindrical shape and may be, for example, a polygonal column shape.

According to the third embodiment described above, the same effect as in the first embodiment described above may be obtained even with the surgical microscope system 300.

### Other Embodiments

The constituent components disclosed in the medical observation systems according to the first to third embodiments of the present disclosure described above may be combined appropriately to form variations. For example, some of the constituent components may be eliminated from all components described in the medical observation system according to the first to third embodiments of the present disclosure described above. Further, it is also possible to appropriately combine the constituent components described in the medical observation system according to the first to third embodiments of the present disclosure described above.

In addition, in the medical observation system according to the first to third embodiments of the present disclosure, the “unit” may be replaced by “means”, “circuit”, or the like. For example, the control unit may be replaced by control means or a control circuit.

In addition, a program executed by the medical observation system according to the first to third embodiments of the present disclosure is recorded in a recording medium readable by a computer, such as a CD-ROM, a flexible disk (FD), a CD-R, a digital versatile disk (DVD), a USB medium, or a flash memory and provided as file data in an installable format or an executable format.

Further, the program executed by the medical observation system according to the first to third embodiments of the present disclosure may be stored in a computer connected to the network such as the Internet and provided by downloading via the network.

Note that in the description of the timing chart in the present specification, the context of timing of the processing steps is clearly indicated using expressions such as “first”, “after”, “follow”, and so on, but these expressions do not uniquely determine the order of the processing steps for implementing the present disclosure. That is, the order of the processing steps in the timing chart described in the present specification may be changed within a non-contradictory range.

As described above, some of the embodiments of the present application have been described in detail with reference to the accompanying drawings, but these are merely examples, and the present disclosure may be implemented in various other embodiments modified or improved according to the knowledge of those skilled in the art in addition to the embodiments described in the present disclosure.

According to the present disclosure, even when an image is output to a plurality of display devices having different resolutions, it is possible to prevent the lowering of the resolution.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image processing device comprising:
a memory; and
a processor comprising hardware, wherein the processor is configured to:
execute, on first observed image information input externally and having predetermined number of pixels generated by capturing a subject, expansion processing to expand number of pixels up to a resolution of a display configured to display a display image having highest resolution among a plurality of displays being connectable to the image processing device, and generate and output second observed image information having number of pixels larger than the predetermined number of pixels; and
execute reduction processing to reduce the number of pixels on the second observed image information, and generate and output third observed image information having number of pixels smaller than the predetermined number of pixels.

2. The image processing device according to claim 1, wherein the processor is configured to:
execute, on the first observed image information, interpolation processing to interpolate the pixels up to the resolution of the display configured to display the display image having the highest resolution as the expansion processing, and generate and output the second observed image information; and
execute, on the second observed image information, decimation processing to decimate the number of pixels as the reduction processing, and generate and output the third observed image information.

3. The image processing device according to claim 1, wherein
the processor is connected to:
a first output unit connected to a first display configured to display an image having number of pixels equal to the number of pixels of a second observed image corresponding to the second observed image information; and
a second output unit connected to a second display configured to display an image having number of pixels equal to the number of pixels of a third observed image corresponding to the third observed image information, and
the processor is configured to output the second observed image information to the first output unit and output the third observed image information to the second output unit.

4. The image processing device according to claim 1, wherein
the first observed image information has the number of pixels larger than number of pixels of a Full HD image, and
the processor is configured to:
execute the expansion processing on the first observed image information and generate and output the second observed image information having the number of pixels equal to a number of pixels of a 4K image; and
execute the reduction processing on the second observed image information and generate and output the third observed image information having the number of pixels equal to the number of pixels of the Full HD image.

5. An image processing method executed by an image processing device, the method comprising:
executing, on first observed image information input externally and having predetermined number of pixels generated by capturing a subject, expansion processing to expand number of pixels up to a resolution of a display configured to display a display image having highest resolution among a plurality of displays being connectable to the image processing device, and generating and outputting second observed image information having number of pixels larger than the predetermined number of pixels; and
executing reduction processing to reduce the number of pixels on the second observed image information, and generating and outputting third observed image information having number of pixels smaller than the predetermined number of pixels.

6. A non-transitory computer readable recording medium on which an executable program for processing an image, the program instructing a processor of an image processing device to execute:
executing, on first observed image information input externally and having predetermined number of pixels generated by capturing a subject, expansion processing to expand number of pixels up to a resolution of a display configured to display a display image having highest resolution among a plurality of displays being connectable to the image processing device, and generating and outputting second observed image information having number of pixels larger than the predetermined number of pixels; and
executing reduction processing to reduce the number of pixels on the second observed image information, and generating and outputting third observed image information having number of pixels smaller than the predetermined number of pixels.
